(19) United States
(12) Patent Application Publication
(10) Pub. No.: US 2025/0217824 A1
(43) Pub. Date: Jul. 3, 2025

(54) CONSUMER PRODUCT TRACKING BASED ON SIGNALS FROM SMART DEVICES

(71) Applicant: Georama, Inc., Chicago, IL (US)

(72) Inventor: Nihal Advani, Chicago, IL (US)

(21) Appl. No.: 19/001,293

(22) Filed: Dec. 24, 2024

Related U.S. Application Data
(60) Provisional application No. 63/615,175, filed on Dec. 27, 2023.

(51) Int. Cl. G06Q 30/0201; G06K 19/07; G06Q 10/087; G06V 10/764

(52) U.S. Cl. CPC G06Q 30/0201; G06K 19/0723; G06Q 10/087; G06V 10/764

(57) ABSTRACT

Methods, systems, and apparatus, including computer programs encoded on a computer storage medium, for smart device product tracking. In one aspect, a system includes: a sensor configured to sense a change in a state of a door of the cabinet; a camera module including a camera, communicatively coupled to the sensor, and configured to acquire images of an interior of the cabinet in response to a change in the state of the cabinet door sensed by the sensor; a communication module communicatively coupled to the camera, and configured to wirelessly transmit image data that includes the images of the interior of the cabinet; and a computing device remote from the cabinet, communicatively coupled to the communication module, and configured to receive the image data and analyze the image data to generate tracking data related to use of the consumer product based on the analysis of the image data.

### RELATED APPLICATION

This application claims priority under 35 U.S.C. § 119(c) to U.S. Provisional Application Ser. No. 63/615,175, filed on Dec. 27, 2023, the disclosures of which are incorporated herein by reference in their entirety.

### TECHNICAL FIELD

The subject matter described herein relates to systems configured to generate tracking data for a consumer product that characterizes, e.g., consumption or usage of the product by a consumer.

### BACKGROUND

Merchants (e.g., manufacturers, distributors, retailers, and/or the like) can benefit from identifying consumption behavior that indicates how users (e.g., consumers) interact with a product (e.g., how users purchase, perceive, and/or either consume or use the product). For example, a merchant can interpret consumption behavior to understand the needs, desires, habits, patterns, preferences, and problems of users. Based on the understanding of the needs, desires, habits, patterns, preferences, and problems of the users, the merchant may make several changes and identifications to maximize sales and customer satisfaction. Such changes include modifications to: where the product is placed within various distribution channels; structural details or other features of the product; packaging of the product; content of messaging in a digital component related to the product; mode (e.g., email or text message) of transmitting the digital component to respective users; timeline for launching new products; and/or the like. Such identifications include identifications of new opportunities, new segments of target audience, geographies for various business processes (e.g., marketing, sales, manufacturing), and/or the like.

However, traditional techniques for collecting and understanding consumption or usage behavior may not be optimal. For instance, while merchants have a significant amount of data on the purchase behavior of consumers based on retailer data and/or their own sales data, they typically have little to no idea about the behavior of actual consumption or usage of those products by the consumers (e.g., users) of those products after the products have been purchased by those consumers. In some instances, merchants may—either themselves or through other companies—conduct ad-hoc research studies or tap into syndicated research data to try to determine consumption behavior. However, such studies and research activities are ineffective for many reasons. First, such studies provide some indication of consumption behavior during a particular point in time rather than over a long period of time that can better indicate consumer behavior. Second, such studies and research activities generate results based on data of usage informed by the consumers instead of being based on actual consumption, which may not match what the user informs, and thus such results can be inaccurate. Third, some such studies may involve a company representative visiting homes or other locations of the users to check on usage, but such practices may be unduly burdensome, cost-prohibitive, and discouraged by the users.

Due to such ineffectiveness, such conventional studies and research activities do not allow the merchants to obtain deep, authentic, and accurate insights into behavior of consumption or usage of the product by the consumers or users. For example, the merchants are traditionally unable to obtain insights (a) based on actual consumption or use of the product, (b) in an automatic manner, (c) in a fast or timely manner, such as in real-time, (d) that are scalable for large amounts of users, regions, categories, markets, (e) that are ongoing over the life of the product, or a long period of time such as several weeks, months, or years, (f) that are presented in a clear easy-to-comprehend manner. This ineffectiveness of the traditional techniques for collecting and understanding consumption behavior prevents those merchants from providing effectively targeted recommendations, advertisements, promotions, or messaging to the consumers or users, which in turn hinders the ability of the merchants to develop new products that are effective for those, and/or similar, consumers or users.

### SUMMARY

A system for consumer product tracking is described that cures at least some of the above-noted deficiencies of the traditional techniques for collecting and understanding consumption or usage behavior while attaining many advantages. The consumer product tracking system includes a sensor sub-system that obtains measurements indicative of, e.g., presence, movement, or absence, of the consumer product at a location, e.g., inside a cabinet for storing the consumer product, or at multiple locations within a residential property.

Throughout this specification, the term “cabinet” refers to any appropriate type of enclosure or structure that can store the consumer product, e.g., fridge, a cupboard, e.g., a cupboard under a sink, kitchen cupboard, garage cupboard, a shelf, or any other appropriate type of cupboard. The consumer product tracking system can generate tracking data that includes measurements obtained by the sensor sub-system that indicate a presence or movement of the consumer product at one or more locations, e.g., over a period. The tracking data can be processed by a machine learning algorithm, or in any other appropriate manner, to generate insights into consumption or usage of the consumer product by the consumer. Generally, the tracking data can include, e.g., location of the consumer product, time of consumption or usage of the consumer product, data identifying the consumer product, and/or any other appropriate type of data that can characterize consumption or usage of the consumer product.

The consumer product tracking system is adapted to track the consumer product in a privacy-sensitive manner, e.g., in a manner that preserves the identity of consumers. The consumer product can be any product that is consumed or used by a consumer, such as food products, drugs (e.g., medications), drinks, cleaning supplies, products for hygiene, or any other appropriate type of product that can be used or consumed by the consumer. The tracking data, as generated by the system, over a period can indicate consumption behavior of the consumer with respect to that product.

The sensor sub-system is configured to be coupled—physically and/or communicatively over a communication network—to a communication module. The sensor sub-system obtains measurements that track the consumer product and transmits measurements to a remote computing device via the communication module. The remote computing device can include, e.g., a backend server, which generates insights based on the tracking data. In some implementations, the sensor sub-system and the communication module are disposed in a proximity to the consumer product, e.g., inside the cabinet for storing the consumer product, while the remote computing device is disposed remotely from the consumer product and/or the cabinet.

This specification describes multiple implementations of the sensor sub-system. In one example, the sensor sub-system includes a sensor configured to sense opening/closing of a cabinet door of the cabinet for storing the consumer product, and a camera configured to capture images of an interior of the cabinet in response to the sensed opening/closing of the cabinet door. In another example, the sensor sub-system includes a smart tag attached to the consumer product and a placement mat for supporting the consumer product. The smart tag can be, e.g., a Near-Field Communication (NFC) tag, while the placement mat can include electronics configured to read the NFC tag. In yet another example, the sensor sub-system includes a tracker device coupled to the consumer product, where the tracked device includes a switch and a transmitter. The switch triggers the transmitter to transmit a signal that is received by a received. Each of the example implementations of the sensor sub-system can additionally include any other sensors/components that can assist the sensor sub-system in obtaining measurements that track the consumer product. In some cases, the consumer product tracking system includes multiple sensor sub-systems disposed in different cabinets/locations. For example, a first sensor sub-system can be disposed inside a fridge, while a second sensor sub-system can be disposed under the sink. Each of the sensor sub-systems can be configured to track the consumer product at the respective location.

As described above, the remote computing device generates insights based on the tracking data. Some of the insights can be generated specifically for the consumer of the consumer product, and some of the insights can be generated specifically for a merchant of (or an entity associated with) the consumer product. The insights specific to the consumer can be provided to a communication device of the consumer, and the insights specific to the merchant can be provided to a client device of the merchant.

In one aspect, there is provided a system that includes: a sensor configured to sense a change in a state of a door of the cabinet; a camera module including a camera, the camera module being communicatively coupled to the sensor, the camera module being configured to acquire images of an interior of the cabinet in response to a change in the state of the cabinet door sensed by the sensor; a communication module communicatively coupled to the camera, the communication module being configured to wirelessly transmit image data that includes the images of the interior of the cabinet; and a computing device remote from the cabinet and communicatively coupled to the communication module, the computing device being configured to receive the image data and analyze the image data to generate tracking data related to use of the consumer product based on the analysis of the image data.

The foregoing and other embodiments can each optionally include one or more of the following features, alone or in combination. In some implementations, the sensor can include one or more of: a motion sensor, a proximity sensor, a location sensor, a light sensor, and a touch sensor. The camera module can include a housing having a front side and a back side, the camera can include a camera lens arranged to image a field on the front side of the camera module, and an attachment means configured to attach the back side to a surface of the interior of the cabinet. The attachment means can include an adhesive tape or one or more suction cups. The camera module further can include a light source configured to illuminate an interior of the cabinet during the acquisition of the images. The camera can be configured to capture the images of the interior portion of the cabinet at regular time intervals. The camera module further can include an ambient light sensor. The ambient light sensor can be configured to sense the change in the state of the cabinet for storing the consumer product. The camera lens can be a wide-angle lens or a fisheye lens. The camera can include a field of view in at least once direction of 80 degrees or more. The remote computing device can be configured to analyze the image data of the cabinet using a machine learning model. The machine learning model can be an image recognition machine learning model. The consumer product can be selected from the group consisting of a consumer packaged good (CPG), a medication, a fast moving consumer good (FMCG), and a food & beverage (F&B). The communication module can include a module selected from the group consisting of a Wi-Fi module, a Bluetooth module, a Bluetooth Low Energy module, and a SIM module. The tracking data can include information identifying a type of the consumer product. The tracking data can include information that the consumer product has been removed from the cabinet and/or information that the consumer product has been placed in the cabinet. The camera can be configured to periodically acquire the images. The cabinet can be a refrigerator, a freezer, or a cupboard.

In one aspect, there is provided a method that includes the actions of sensing, by a sensor coupled to a cabinet, a change in a state of a cabinet door of the cabinet; in response to the sensed change in the state of the cabinet door, capturing, by a camera, images of an interior portion of the cabinet; wirelessly transmitting, by a communication module communicatively coupled to the camera, image data can include the images of the interior of the cabinet; and analyzing, by a remote computing device communicatively coupled to the communication module, the image data to generate tracking data related to use of the consumer product based on the analysis of the image data.

The foregoing and other embodiments can each optionally include one or more of the following features, alone or in combination. In some implementations, analyzing, by the remote computing device communicatively coupled to the communication module, the image data to generate tracking data for the consumer product can include: processing, by the remote computing device, the image data to determine an activity performed by a consumer associated with the consumer product. The actions can include generating, by the remote computing device, a report on consumption or use of the consumer product by the consumer based on the tracking data for the consumer product; and transmitting, from the remote computing device, the report to a merchant device of the merchant of the consumer product.

In one aspect, there is provided a system that includes: a smart tag configured to be attached to a consumer product; a placement mat that includes a surface configured to support the consumer product, and includes electronics configured to: read the smart tag in response to a sensed change in a state of the consumer product, where the sensed change in the state of the consumer product can include moving of the consumer product relative to the placement mat; and based on reading the smart tag, generate identification data for the consumer product; a communication module communicatively coupled to the placement mat, the communication module configured to wirelessly transmit the identification data; and a remote computing device communicatively coupled to the communication module, the remote computing device configured to receive the identification data and generate tracking data for the consumer product based on the identification data.

The foregoing and other embodiments can each optionally include one or more of the following features, alone or in combination. In some implementations, the smart tag can be a Near Field Communication (NFC) tag, a Radio Frequency Identification (RFID) tag, or a Bluetooth tag. The electronics can be configured to read a plurality of smart tags simultaneously. The smart tag can include an adhesive for attaching the smart tag to the consumer product. The communication module can include one or more antennae. The smart tag can be a reusable smart tag configured to be attached to a second different consumer product after detachment from the consumer product. The movement of the consumer product relative to the placement mat can include removing the consumer product from the placement mat or placing the consumer product on the placement mat. The communication module can be integrated with the placement mat and the communication module can include a Wi-Fi module. The placement mat further can include a power source configured to supply power to the placement mat. The smart tag can be attached to the consumer product on a surface of the consumer product that can be in direct contact with the surface of the placement mat. The placement mat can include a sensor configured to: sense the change in the state of the consumer product; and in response to the sensed change in the state of the consumer product, trigger the placement mat to read the smart tag attached to the consumer product. The sensor can be an accelerometer or a vibration sensor. The smart tag can be an active tag or a passive tag. The computing device can be configured to program the smart tag with information regarding the consumer product. The placement mat can be configured to read the smart tag of each of a plurality of consumer products that can be stacked on the surface of the placement mat.

In one aspect, there is provided a method that includes the actions of providing a smart tag for attachment to a consumer product; providing a placement mat for supporting the consumer product; sensing, using the placement mat, a change in a state of the consumer product, the sensed change in the state of the consumer product can include movement of the consumer product relative to the placement mat; in response to the sensed change, reading, using the placement mat, the smart tag attached to the consumer product to generate identification data for the consumer product; wirelessly transmitting, by a communication module communicatively coupled to the placement mat, the identification data for the consumer product; and analyzing, by a remote computing device communicatively coupled to the communication module, the identification data for the consumer product to generate tracking data for the consumer product.

In one aspect, there is provided a system that includes: a tracker device configured to be coupled to a consumer product, the tracker device can include a switch and a transmitter, the switch being configured to trigger the transmitter to transmit an identification signal in response to a sensed change in a state of the consumer product, where the sensed change in the state of the consumer product can include moving the consumer product relative to a cabinet in which the consumer product can be placed; a receiver disposed at an interior portion of the cabinet, the receiver configured to receive the identification signal from the transmitter; and a remote computing device communicatively coupled to the receiver, the remote computing device configured to receive the identification signal from the receiver and generate tracking data for the consumer product based on the identification signal.

The foregoing and other embodiments can each optionally include one or more of the following features, alone or in combination. In some implementations, the transmitter can be configured to transmit an optical signal or a radio wave signal. The optical signal can include an infrared (IR) light sequence. The switch can be a mechanical switch. The tracker device further can include a power source configured to supply a power to the tracker device. The identification signal can be a pre-programmed code associated with the tracker device. The consumer product can include a container having top surface and a bottom surface opposite the top surface, and where the tracker device can be coupled to the container proximate to the bottom surface. The receiver can be disposed proximate to the top surface. The switch can be a push button. The transmitter can have a duty cycle in a range from 40% and 60%.

In one aspect, there is provided a system that includes: a tracker device coupled to a consumer product disposed in a cabinet, the tracker device including a switch and a transmitter; triggering, by the switch, the transmitter to transmit an identification signal in response to a sensed change in a state of the consumer product, where the sensed change in the state of the consumer product can include movement of the consumer product relative to the cabinet; receiving, by a receiver disposed at an interior portion of the cabinet, the identification signal from the transmitter; and analyzing, by a remote computing device communicatively coupled to the receiver, the identification signal to generate tracking data for the consumer product.

Related systems, devices, methods, non-transitory computer program products, processors, machine readable media, and articles of manufacture are within the scope of this disclosure. For instance, other embodiments can include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The subject-matter described herein can provide many advantages. For example, the systems and techniques described herein allow merchants to obtain deep, authentic, and accurate insights about behavior of consumption or usage of one or more products by the consumers or users of those one or more products. For example, such systems and techniques allow the merchants to obtain insights (a) based on actual consumption or use of the product, (b) in an automatic manner, (c) in a fast or timely manner, such as in real-time, (d) that are scalable for large amounts of users, regions, categories, markets, (c) that are ongoing over the life of the product, or a long period of time such as several weeks, months, or years, (f) that are presented in a clear easy-to-comprehend manner. Effectiveness of the systems and techniques described herein for collection and understanding of consumption behavior enables those merchants to provide accurately targeted recommendations, advertisements, promotions, or messaging to the consumers or users, which in turn allows the merchants to develop new products that are effective for those, and/or similar, consumers or users.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

FIG. 1 is a block diagram of an example system for consumer product tracking.

FIG. 2 is a block diagram of an example sensor sub-system having a first architecture.

FIG. 3 illustrates an example camera module included in the first architecture of the sensor sub-system.

FIG. 4 illustrates a top view of an example attachment of the camera.

FIG. 5 illustrates an example implementation of the first architecture of the sensor sub-system.

FIG. 6 is a block diagram of an example sensor sub-system having a second architecture.

FIG. 7 illustrates an example placement mat included in the second architecture of the sensor sub-system.

FIG. 8A and FIG. 8B illustrate example electronics included in the placement mat of the second architecture.

FIG. 9A and FIG. 9B illustrate example smart tags included in the second architecture.

FIG. 10A and FIG. 10B illustrate example attachments of the smart tags included in the second architecture.

FIG. 11 is a block diagram of an example sensor sub-system having a third architecture.

FIG. 12 is a block diagram of an example computer system that can be used to perform operations described herein.

Like reference numbers and designations in the various drawings indicate like elements.

### DETAILED DESCRIPTION

### General Overview

A consumer product tracking system is described that can generate insights based on tracking data for a consumer product that characterizes consumption or usage of the product by a consumer. The system includes a sensor sub-system that can obtain measurements for the consumer product indicative of, e.g., presence, movement, or absence, of the consumer product at a location, e.g., inside a cabinet for storing the consumer product, and any other appropriate location within a residential property. In some cases, the sensor sub-system can measure characteristics such as, e.g., location, time of consumption or usage, and/or the like, of the consumer product. The system further includes a communication module that transmits tracking data based on the measurements obtained by the sensor sub-system to a remote computing device. The remote computing device performs machine learning on the tracking data received from the communication module to generate insights into behavior of consumption or usage of the product by the consumer, and/or recommendations for the merchant or the consumer of the consumer product. Various architectural modifications are possible, as explained in greater detail below.

The recommendations for the consumer can help the consumer modify consumption or usage habits to improve the quality of life. The recommendations for the merchant can help the merchant assess their product campaigns, and make modifications to the formation of products, content of products, manufacturing processes, advertising campaigns, distribution channels, and/or any other purpose.

### An Example Consumer Product Tracking System

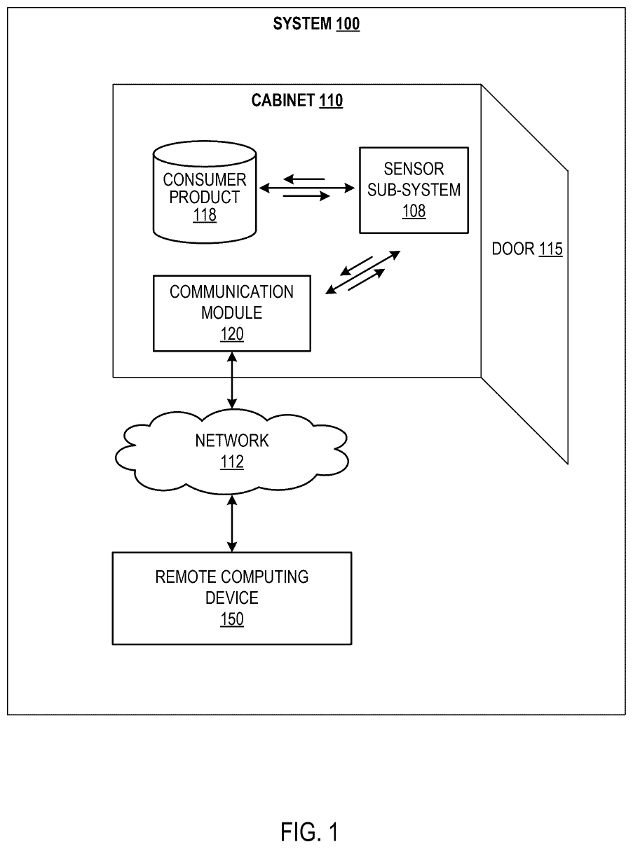

FIG. 1 illustrates a consumer product tracking system 100 that generates insights on behavior of usage or consumption of a consumer product 118 by a user or a consumer, in accordance with some implementations described herein. The consumer product 118 is any tangible good that can be consumed or used. For example, the consumer product 118 can include household cleaning items, consumer packaged goods, food and beverages, and/or the like. The system 100 can include a sensor sub-system 108, a communication module 120, a remote computing device 150, and a communication network 112. In some cases, the system 100 further includes a communication device associated with the consumer of the consumer product 118 and/or a client device associated with a merchant of the consumer product 118.

The sensor sub-system 108 and the communication module 120 can be disposed at a location for storing the consumer product 118, e.g., the sensor sub-system 108 and the communication module 120 can be coupled to a storage cabinet 110 for storing the consumer product 118 or disposed at any other appropriate location where the consumer product 118 is being stored or used. The storage cabinet 110 can be any appropriate enclosure for storing the consumer product 118, e.g., a fridge, a cabinet under a sink, a kitchen cabinet, or any other appropriate type of enclosure. The remote computing device 150 is disposed remotely from the cabinet 110 for storing the consumer product 118. However, in some cases, the remote computing device 150 is disposed inside the cabinet 110 for storing the consumer product 118. The remote computing device 150 communicates with the communication module 120 through the communication network 112. The sensor sub-system 108 can communicate with the communication module 120 through a physical coupling or the communication network 120.

The sensor sub-system 108 obtains measurements that track the consumer product 118 at a location (e.g., the storage cabinet 110), e.g., the sensor sub-system 108 can detect presence, movement, or absence, of the consumer product 118 inside the cabinet 110 for storing the consumer product 118. As a particular example, the measurements can characterize, e.g., location of the consumer product 118, time of consumption or usage of the consumer product 108, and/or any other appropriate parameter that can provide insight into the consumption or usage of the product 118 by the consumer.

This specification describes three example architectures of the sensor sub-system 108, which are provided for illustrative purposes only. Generally, the sensor sub-system 108 can be implemented by one, or a combination, of the components described throughout this specification, and not necessarily according to the three example architectures described herein.

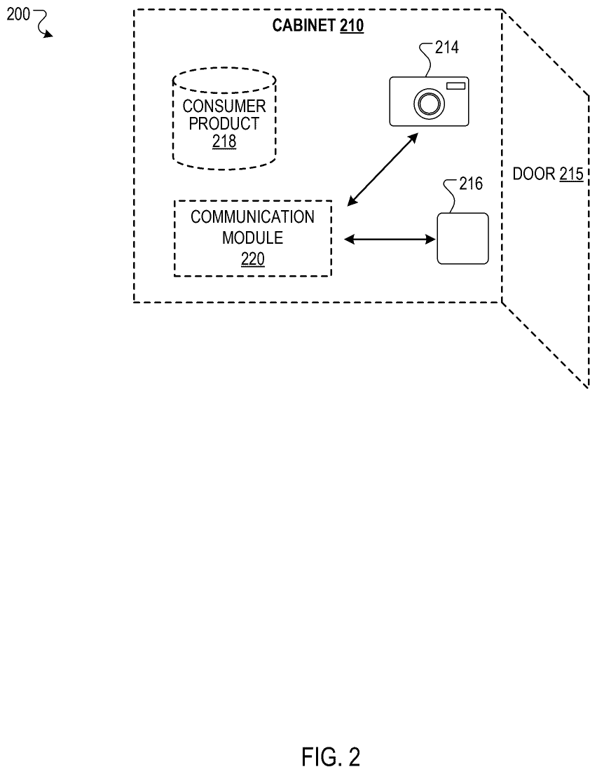

According to a first example architecture, the sensor sub-system 108 includes a sensor configured to sense a change in a state of the cabinet for storing the consumer product, e.g., detect when a door of the cabinet is opened or closed. The first example architecture further includes a camera module configured to capture images of an interior portion of the cabinet in response to the sensed change in the state of the cabinet by the sensor. As a particular example, the sensor sub-system 108 having the first architecture detects when the door 115 is opened and, in response, captures one or more images that indicate presence, movement, or absence, of the consumer product 118 inside the cabinet 110. This implementation is described in more detail below with reference to FIG. 2.

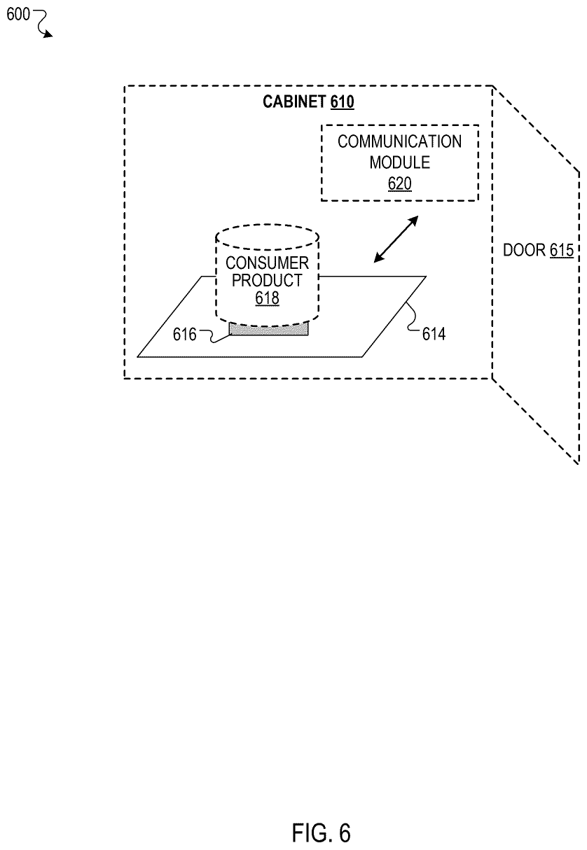

According to a second example architecture of the sensor sub-system 108, the sensor sub-system 108 includes a smart tag (e.g., a Near-Field Communication tag) configured to be attached to the consumer product 118. The second example architecture further includes a smart placement mat (e.g., a Near-Field Communication placement mat) that includes electronics configured to read the smart tag in response to a sensed change in a state of the consumer product, e.g., in response to the product being displaced, or otherwise moved, from the smart placement mat. As a particular example, the sensor sub-system 108 having the second architecture detects when the consumer product 118 is moved and, in response, detects a type, or an identity, of the consumer product 118, by reading the smart tag affixed to the consumer product 118. This implementation is described in more detail below with reference to FIG. 6.

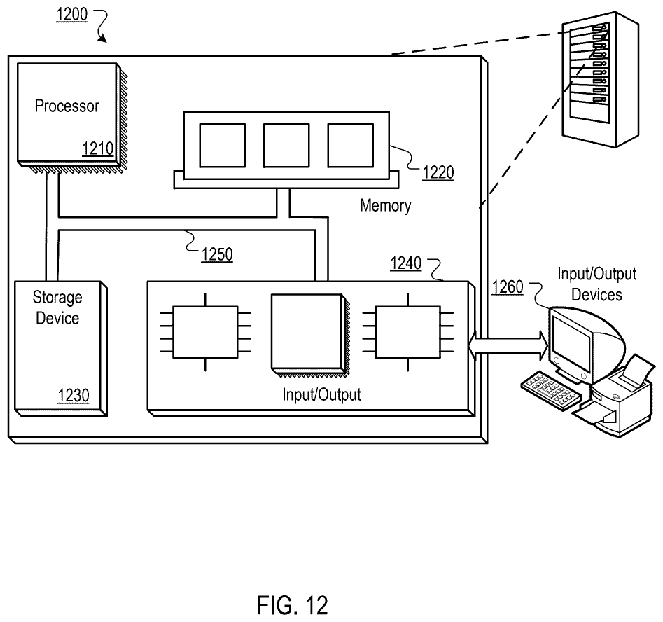

According to a third example architecture of the sensor sub-system 108, the sensor sub-system 108 includes a tracker device configured to be coupled to the consumer product 118. The tracker device includes a switch and a transmitter, the switch being configured to trigger the transmitter to transmit an identification signal (e.g., a light signal or a radio frequency signal that identifies the consumer product 118) in response to a sensed change in a state of the consumer product, e.g., a movement of the consumer product 118. This implementation is described in more detail below with reference to FIG. 12.

The sensor sub-system 108 can include any appropriate types of sensors configured to perform the functions described above, and any additional types of sensors, e.g., motion sensors (e.g., an accelerometer), time sensors, location sensors, temperature sensors, proximity sensors, infrared sensors, ultrasonic sensors, humidity sensors, tilt sensors, level sensors, touch sensors, and/or the like.

The remote computing device 150 can receive tracking data that includes measurements obtained by the sensor sub-system 108 (e.g., images of the interior of the cabinet, data identifying the consumer product, or any other appropriate measurements depending on the architecture of the sensor sub-system 108), and process the tracking data using machine learning techniques, or in any other appropriate manner, to generate insights into consumption or usage of the consumer product 118 by the consumer and/or recommendations based on the insights. Each of the insights and the recommendations can be generated for (i) an entity that deals with the product 118, such as a merchant (e.g., manufacturers, distributors, retailers, and/or the like) of the product 118, or (ii) the consumer who consumes or uses the product 118.

The consumer product tracking system 100 can further include a client device of the merchant, e.g., a computing system (e.g., computer) configured to be operated by the merchant (e.g., manufacturers, distributors, retailers, and/or the like) of the consumer product 118. The system 100 can further include a computing device of the consumer of the consumer product 118, e.g., phone, tablet computer, phablet computer, a laptop, or the like, configured to be operated by the consumer or user of the product 118. The remote computing device 150 can transmit the insights and/or the recommendations specific to the consumer over the communication network 112 to the computing device of the consumer of the consumer product 118, and insights and/or the recommendations specific to the merchant of the consumer product 118 to the client device of the merchant.

### Examples of Consumer Product

Some examples of the consumer product 118, as described herein, include cleaning liquids, wipes, sprays, floor cleaning pads, body-wash, shampoo, hand-soap, sauce cans, beverages, alcohols and/or the like. The consumer product 118 can be categorized as customer packaged goods (CPG), fast-moving consumer goods (FMCG), and/or food and beverages (F&B). The CPG and F&B may include categories that includes dish care (e.g. dishwashing liquid, dishwasher pods, dishwasher spray and/or dishwasher detergent), household cleaning (e.g. surface wipes & sprays, all-purpose sprays, air freshening sprays, liquid floor cleaners and/or pad based systems), laundry & fabric care (e.g. laundry liquid, detergent, pods, fabric refresher spray, fabric softener and/or dryer sheet), personal cleaning (e.g. skin care, body wash, moisturizers, hair care, shampoo/conditioner, hand soap and/or shaving gel), family care (e.g. paper towels and/or facial tissues), fragrance (e.g. perfumes and/or deodorants), feminine care, oral care (e.g. mouthwash and/or toothpaste) and/or personal health.

### Example Materials Forming the Sensor Sub-System

As described above with reference to FIG. 1, one or more components of the sensor sub-system 108 can be disposed at a location that is proximate to the consumer product 118, e.g., one or more components of the sensor sub-system 108 can be disposed inside the cabinet 110 (e.g., fridge, kitchen cabinet, or the like) for storing the consumer product 118.

One or more components of the sensor sub-system 108, and/or a housing of one or more components of the sensor sub-system 108, can be made of materials that remain stable and fully operational at a temperature of storage or operation of the consumer product 118.

In some examples, one or more components of the sensor sub-system 108, and/or a housing of one or more components of the sensor sub-system 108, can be configured to remain stable and fully operational in a wide temperature range, which in some examples can range from −40° C. to 150° C., in certain examples can range from 0° C. to 100° C., in few examples can range from 0° C. to 50° C. The sensor sub-system 108 (or one or more components thereof) can have protection mechanisms to avoid being harmed from spill or leakage of the consumer product 118. For example, in some implementations, one or more components of the sensor sub-system 108 can have a liquid proof or liquid resistance (e.g., waterproof or water resistant) housing, which can be advantageous where the consumer product 118 is a liquid as the component may not be damaged by spill or leakage of the consumer product 118. The liquid proof or liquid resistant housing can be made with liquid proof or liquid resistance materials, such as polyurethane laminate (PUL), thermoplastic polyurethane (TPU), waxed cotton, nylon, polyester, PVC-coated polyester, laminated fabric, enameled cloth, polyester fleece, microfiber, wool, vinyl, pleather, and plastic.

One or more components of the sensor sub-system 108 can additionally or alternately be made of materials that have a low coefficient of friction and are abrasion resistance, such as polytetrafluorocthylene (PTFE). Such materials can prevent or reduce friction and abrasions, and thus advantageously clongate the life of the sensor sub-system 108.

In some implementations, the materials forming one or more components of the sensor sub-system 108 have a high strength, and some examples of such materials include dense materials such as wood or polymers, and tough materials such as steel. In a few examples, the material forming one or more components of the sensor sub-system 108 may have a high electrical resistivity, and examples of such materials include thermal insulators such as polymers and ceramics. In certain examples, the material forming the one or more components of the sensor sub-system 108 may be flexible or elastic, and some examples of such materials include rubber, thermosets, or rubber. In other examples, the material may be stiff, and some examples of such materials include steel, aluminum alloy or carbon-fiber. In some examples, the material forming the one or more components of the sensor sub-system 108 has a low cost of recycling, and some examples of such materials include metals, as they can be easily sorted, remelted and shaped. In a few examples, the material forming one or more components of the sensor sub-system 108 may have a low energy cost—which can be based on (a) energy required to collect/mine the material, and/or (b) energy required to refine, extract, or synthesize the material—and an example of such material is aluminum.

As described above with reference to FIG. 1, this specification describes three example architectures of the sensor sub-system 108. Different architectures of the sensor sub-system 108 can use respective sets of one or more materials, which can be arranged in a manner that allows compactness and usage efficiency of one or more components of the sensor sub-system 108.

### A First Architecture of the Sensor Sub-System

FIG. 2 is a block diagram of a first architecture of the sensor sub-system 200 (e.g., the sensor sub-system 108 included in the consumer product tracking system 100 in FIG. 1).

As described above with reference to FIG. 1, the sensor sub-system 200 is configured to obtain measurements that track the consumer product 218 at one or more locations, e.g., inside a cabinet 210 for storing the consumer product 218. For example, the sensor sub-system 200 can detect presence, movement, or absence, of the consumer product 218 inside the cabinet 210 for storing the consumer product 218. The consumer product tracking system can process tracking data that includes the measurements obtained by the sensor sub-system 200 to generate insights into consumption or usage of the product 218 by the consumer. The first example architecture of the sensor sub-system 200 includes a sensor 216 configured to sense a change in a state of the cabinet 210 for storing the consumer product 218. The change in the state of the cabinet 210 can be, e.g., opening or closing of a cabinet door 215 of the cabinet 210. In some cases, the sensor 216 detects motion of the door 215 from a distance (e.g., the detection may be performed remotely, without any attachment or wired connection between the door 215 and the sensor 216). In some cases, the sensor 216 is physically coupled to the door 215.

The sensor 216 can be any appropriate type of sensor that can sense the change in the state of the cabinet 210, e.g., the sensor 216 can include one or more of: a motion sensor, a proximity sensor, a location sensor, a light sensor, a touch sensor, an ambient light beacon, or any other appropriate type of sensor. In some cases, the sensor 216 is an infrared-based motion sensor, optics-based motion sensor, radio-frequency-based motion sensor, sound-based motion sensor, vibration-based motion sensor, and/or magnetism-based motion sensor. The infrared-based motion sensor can include passive sensors and/or active sensors. The optics-based motion sensor can include video and/or camera systems. The radio-frequency-based motion sensor can include sensor based on radar, microwave and/or tomographic signals. The sound-based motion sensor can include microphones and/or acoustic sensor. The vibration-based motion sensor can include triboelectric, seismic, and/or inertia-switch sensor. The magnetism-based motion sensor can include magnetic sensors and/or magnetometers.

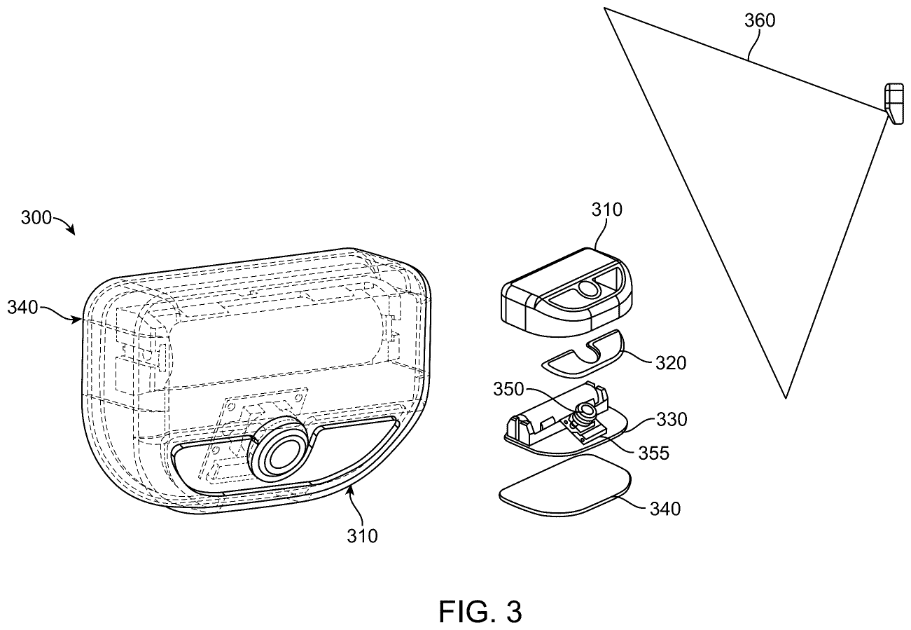

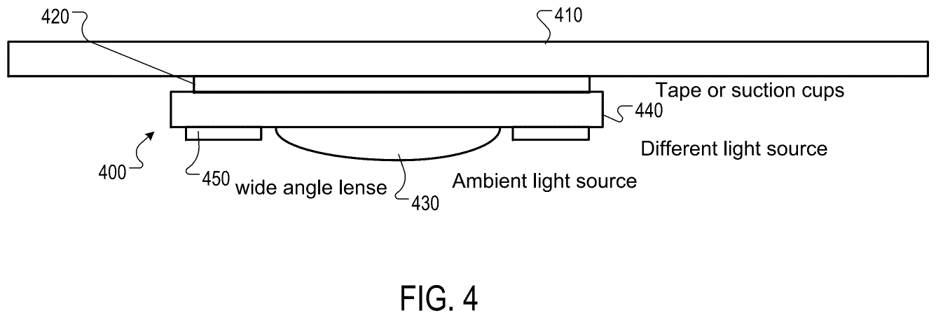

The first architecture of the sensor sub-system 200 further includes a camera module 214 configured to capture images of an interior portion of the cabinet 210 in response to the sensed change in the state of the cabinet 210 by the sensor 216. As described in more detail below with reference to FIG. 3 and FIG. 4, the camera module 214 is configured to be physically coupled to the interior portion of the cabinet 210. For example, the camera module 214 can be attached (e.g., using an adhesive) to any of the walls of the interior portion of the cabinet 210. In some cases, the camera module 214 is configured to be attached to an interior portion of the door 215. As a particular example, the cabinet 210 can include a top portion (e.g., a ceiling) opposite a bottom portion, and the camera module 214 is configured to be attached to an interior portion of the cabinet 210 (e.g., any of the walls of the cabinet 210 or the door 215) at a height between 8 and 12 inches from the bottom portion of the cabinet 210. In some cases, the camera module 214 is configured to be attached to the top portion, or the bottom portion of the cabinet 210. The camera module 214 can capture images by way of audio recording and/or video recording. The audio or video recording can be made in real-time. In some cases, the sensor sub-system 200 includes multiple camera modules, e.g., 2 camera modules, 3 camera modules, or any other appropriate number of camera modules, each coupled to the interior portion of the cabinet 210 at a respective (e.g., different) location. In such cases, each of the camera modules can be coupled to the sensor 216 and the communication module 220 physically, or over a communication network.

The camera module 214 and the sensor 216 of the sensor sub-system 200 are communicatively coupled to a communication module 220, e.g., physically or over a communication network. Example communication networks include Bluetooth communication,

Bluetooth Low energy, Wi-Fi, cellular networks, or any other communication network. Other examples include a low-power, low data rate, and close proximity (e.g., personal area) wireless ad hoc network such as a Zigbee network.

The sensor 216 senses a change in the state of the cabinet 210 (e.g., opening/closing of the door 215) and transmits measurements indicating the sensed change to the communication module 220. In response to the senses change, the communication module 220 triggers the camera module 214 to capture the images of the interior portion of the cabinet 210. The camera module 214 transmits the captured images to the communication module 220. Generally, the camera module 214 can be configured to capture any appropriate number of images, e.g., 1 image, 5 images, 10 images, 100 images, or any other appropriate number of images. After capturing several images of the interior portion of the cabinet 210, the camera module 214 can automatically stop capturing images.

In some cases, instead of being coupled through the communication module 220, the camera module 214 is directly coupled to the sensor 216, physically or over a communication network. In such cases, the camera module 214 is triggered to capture the images directly by the sensor 216 in response to the sensed change in the state of the cabinet 210 by the sensor 216. In some cases, the camera module 214 captures images of the interior portion of the cabinet 210 and transmits the captures images to the communication module 220 at programmed (or programmable) intervals of time (e.g., every 30 seconds, every 15 minutes, every 1 hour, every 3 hours, every 24 hours, or any other time interval).

The camera module 214 included in the first example architecture of the sensor sub-system 200 is described in more detail next with reference to FIG. 3.

### An Example Camera Module Included in the First Architecture of the Sensor Sub-System

FIG. 3 illustrates an example camera module 300 included in the first example architecture of the sensor sub-system (e.g., the sensor sub-system 200 described above with reference to FIG. 2, or the sensor sub-system 108 described above with reference to FIG. 1).

The camera module 300 includes a camera body having a front portion 310 and a back portion 340 opposite the front portion 310. The camera body is configured to be compatible with multiple different types of mounts/attachment mechanisms that allows it to be easily mounted or attached in various ways. The camera body is made from materials that are waterproof and/or prevent condensation moisture build up inside the camera body. In some cases, the front portion 310 and the back portion 340 are made from materials that are transparent to light such that the camera module 300 is substantially invisible inside the cabinet for storing the consumer product. Generally, the camera body can have any appropriate dimensions, e.g., the camera can be relatively small when compared to dimensions of the cabinet for storing the consumer product. As a particular example, the camera body can be, e.g., 90 mm long, 60 mm wide, and 27 mm thick.

The back portion 340 of the camera module 300 is configured to support an attachment means for physically attaching the camera module 300 to an interior portion of the cabinet for storing the consumer product. The camera module 300 is configured to be attached in any appropriate manner, e.g., affixed by way of gluing, adhesion, knitting or threading, welding, and/or any other one or more attachment mechanisms (e.g., Velcro, suction cups, adhesive tape) to any suitable area of the interior portion of the cabinet. The camera module 300 further includes an internal portion that is disposed inside the camera body and between the front portion 310 and the back portion 340 of the camera module 300. The internal portion of the camera module 300 includes a camera lens 350 that faces away from the back portion 340 and a camera sensor 355 (e.g., a multielement CMOS sensor). The internal portion further includes a support lid 320 for supporting the lens 350.

The camera lens 350 is any appropriate type of lens suitable for providing a field of view sufficient for the interior of the cabinet, e.g., a wide-angle lens or a fisheye lens. In some cases, the camera module 300 has a field-of-view 360 of between 70 degrees and 180 degrees (e.g., between 80 degrees and 120 degrees, such as about 90 degrees) in at least one dimension. In some cases, the camera module 300 further includes one or more adjustment mechanisms that facilitate a manual adjustment of an angle of view of the camera module 300, e.g., a tilt of the camera module 300. This allows for the camera module 300 to be configured or adjusted according to a particular form factor of the interior of the cabinet for storing the consumer product. For example, an interior portion of a fridge may require a different angle of view of the camera module 300 than a cupboard under the sink.

The camera module 300 additionally includes a Wi-Fi module disposed inside the camera body and coupled to the internal portion of the camera module, e.g., between the front portion 310 and the back portion 340 of the camera module 300. The Wi-Fi module facilitates communication between the camera module 300 and any other components of the consumer product tracking system (e.g., the communication module and/or the sensor described above with reference to FIG. 2). The Wi-Fi module transmits the images captured by the camera module 300 through the Wi-Fi network to the communication module. As a particular example, the Wi-Fi module supports dual-band 2.4 GHz and 5 GHz communication that facilitates a high-efficiency wireless transmission. In some cases, the camera module 300 is powered by a battery and configured to consume relatively low power. The battery can be primary battery (e.g., designed to be used until exhausted of energy) or rechargeable battery (e.g., can be recharged by virtue of having their chemical reactions reversed by applying electric current to the cell).

In some cases, the camera module 300 remains in a sleep mode (e.g., a low power mode) until it is triggered by the communication module and/or the sensor to capture images of the interior portion of the cabinet. As a particular example, in the sleep mode, the camera module 300 consumes approximately 1 micro-Ampere of power, and in an active (e.g., image capturing) mode the camera module 300 consumes approximately 250 micro-Amperes of power for 1 second of active image capturing. In some cases, the camera module 300 additionally includes one or more storage devices (e.g., internal or external storage devices) for storing the images captured by the camera module 300. In some cases, the camera module 300 is configured to capture images and automatically compress the images to approximately 30% of the original image size. As a particular example, each image captured by the camera is approximately 350 kB in size and an image compressed by the camera module 300 is approximately 100 KB in size.

FIG. 4 illustrates a top view of an example attachment of the camera module 400 (e.g., the camera module 300 described above with reference to FIG. 3) to an interior portion of the cabinet for storing the consumer product. As described above, the camera module 400 is configured to be attached to the interior portion of the cabinet in any appropriate manner, e.g., affixed by way of gluing, adhesion, knitting or threading, welding, and/or any other one or more attachment mechanisms (e.g., Velcro, suction cups, adhesive tape) to any suitable area of the interior portion of the cabinet.

The example of FIG. 4 illustrates an interior wall 410 of the cabinet and an adhesive tape 420 that attaches the back portion 440 of the camera module 400 to the interior wall 410 of the cabinet. In some cases, the tape 420 can attach the camera module 400 to the interior wall 410 of the cabinet in a removable manner, e.g., such that the camera module 400 can be easily detached and re-attached at a different portion of the cabinet. As illustrated in FIG. 4, in some cases, the camera module 400 includes a light source 450 (e.g., a flash). The light source 450 can be automatically used based on the lighting at the place of capture (e.g., inside the cabinet for storing the consumer product). In some implementations, the light source 450 can be manually activated or deactivated. In some cases, the camera module can further include an ambient light sensor, e.g., an ambient light sensor having a relatively low duty cycle and operating at less than 100 micro-Amperes.

While the foregoing example includes adhesive tape 420 as the attachment means, more generally, any appropriate attachment means can be used. Other examples include hook and loop fasters, screws, nails, bolts, or other mechanical fasteners,

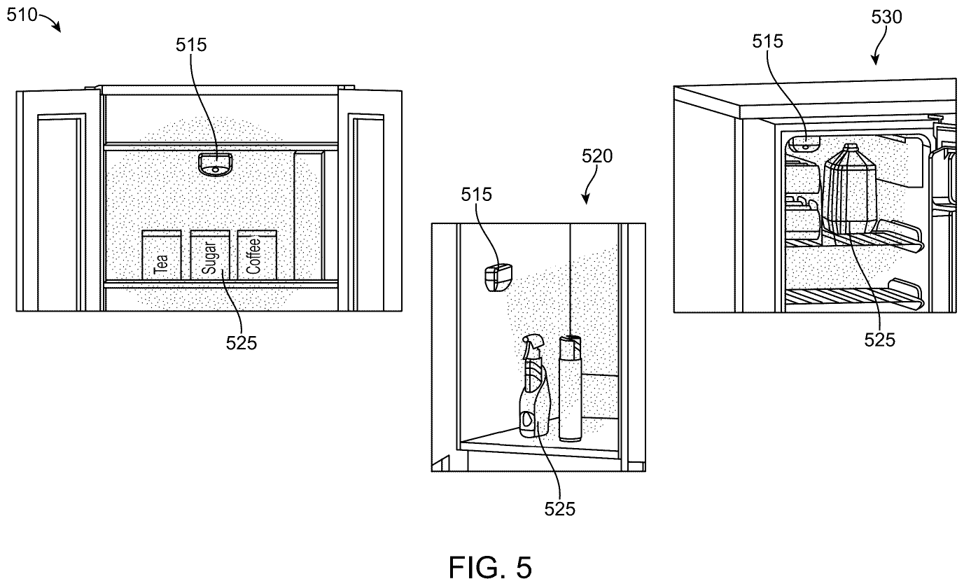

An example implementation of the first example architecture of the sensor sub-system is described in more detail next with reference to FIG. 5.

### An Example Implementation of the First Architecture of the Sensor Sub-System

FIG. 5 illustrates an example implementation of the first architecture of the sensor sub-system (e.g., described above with reference to FIG. 2, FIG. 3, and FIG. 4).

As described above with reference to FIG. 2, the first architecture of the sensor sub-system includes a sensor that senses a change in a state of a cabinet for storing a consumer product and a camera module that captures images of an interior portion of the cabinet in response to the sensed change in the state of the cabinet by the sensor.

FIG. 5 illustrates three different types of cabinets for storing the consumer product, e.g., a kitchen cabinet 510, a cabinet under a sink 520, and a fridge 530. The cabinet 510, 520, 530, includes one or more consumer products 525, a camera module 515 for capturing images of the interior portion of the cabinet (that includes one or more consumer products), and a sensor (not shown) that senses a change in the state of the cabinet.

### A Second Example Architecture of the Sensor Sub-System

FIG. 6 is a block diagram of a second example architecture of the sensor sub-system 600 (e.g., the sensor sub-system 108 included in the consumer product tracking system 100 in FIG. 1). As described above with reference to FIG. 1, the sensor sub-system 600 is configured to obtain measurements that track the consumer product 618 at one or more locations, e.g., inside a cabinet 610 for storing the consumer product 618. For example, the sensor sub-system 600 can detect presence, movement, or absence, of the consumer product 618 inside the cabinet 610 for storing the consumer product 618. The consumer product tracking system can process tracking data that includes the measurements obtained by the sensor sub-system 600 to generate insights into consumption or usage of the product 618 by the consumer.

The second architecture of the sensor sub-system 600 is configured according to Radio Frequency Identification (RFID) technology. Generally, RFID technology includes a tag having a small programmable chip that does not require a power source, and a reader device having one or more antennas. The reader device emits radio waves that interact with the chip included in the tag and receives signals back from the tag. These signals can include information or data that is stored on the programmable chip, e.g., a serial number of the programmable chip.

The sensor sub-system 600 includes a smart tag 616 and a smart placement mat 614 having electronics that are configured to read the smart tag 616, e.g., in a similar way as described above. The smart tag 616 and the smart placement mat 614 can be configured according to any appropriate type of RFID technology, e.g., Near Field Communication (NFC), Bluetooth, or any other appropriate type of RFID technology. The electronics included in the smart placement mat 614 can read the smart tag 616 when the smart tag 616 is within a predetermined distance from the smart placement mat 614, e.g., up to 30 centimeters away from the smart placement mat 614. The RFID technology is advantageous in locations where the consumer product 618 can be stored in a small space (e.g., the cabinet 610) so that detections can be made within the specific distance.

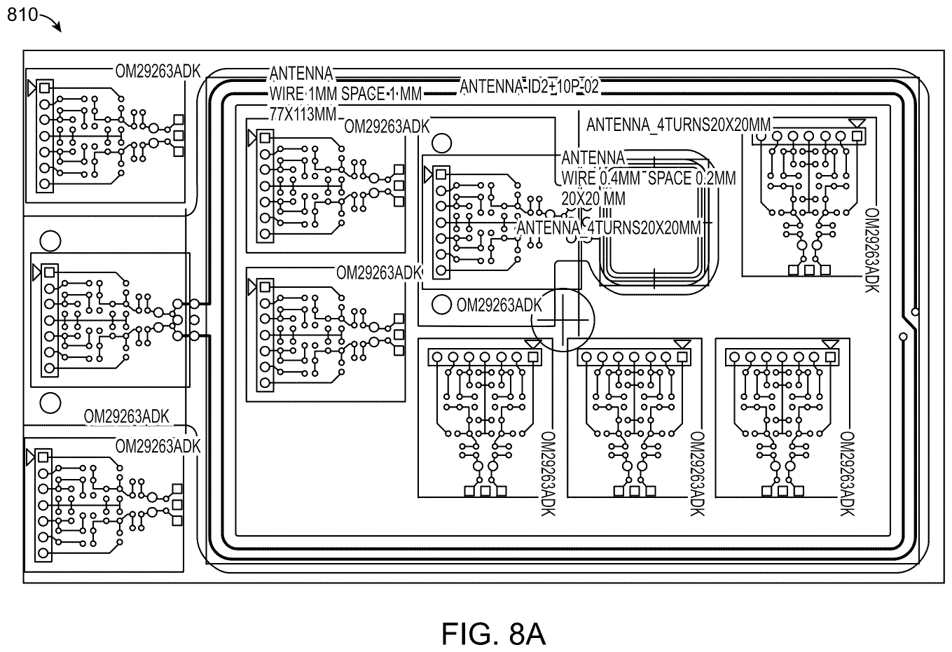

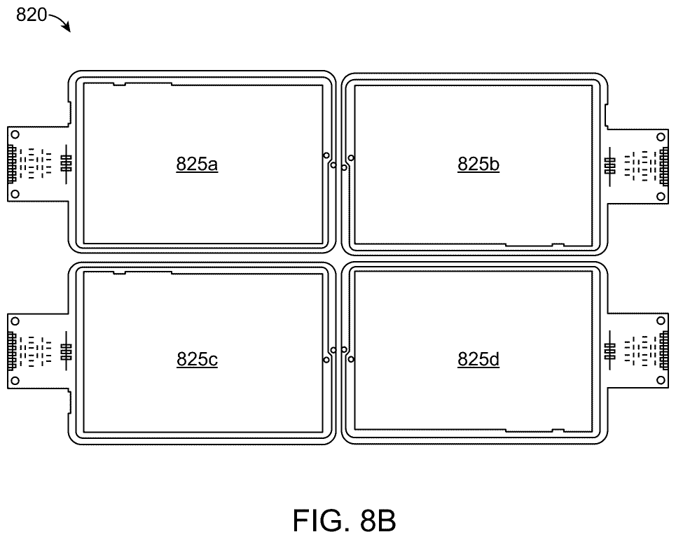

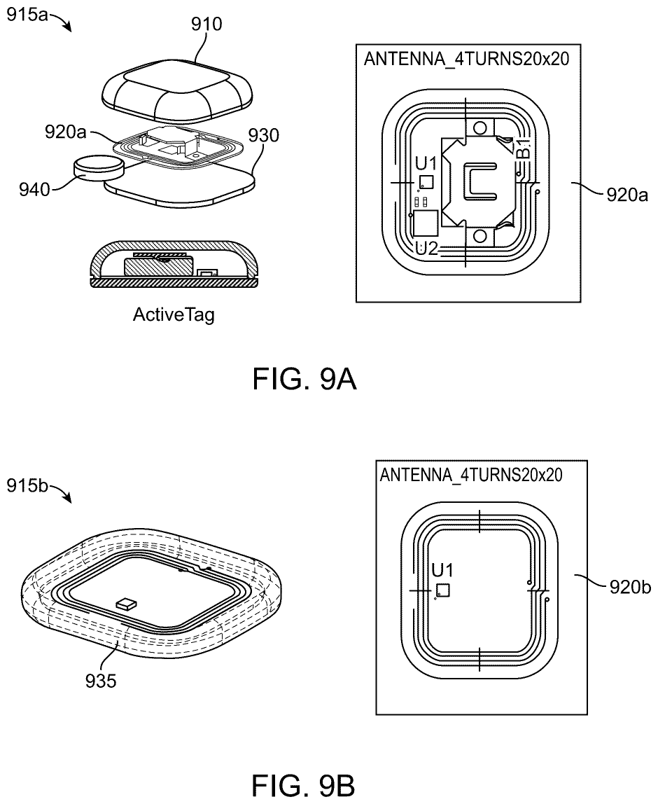

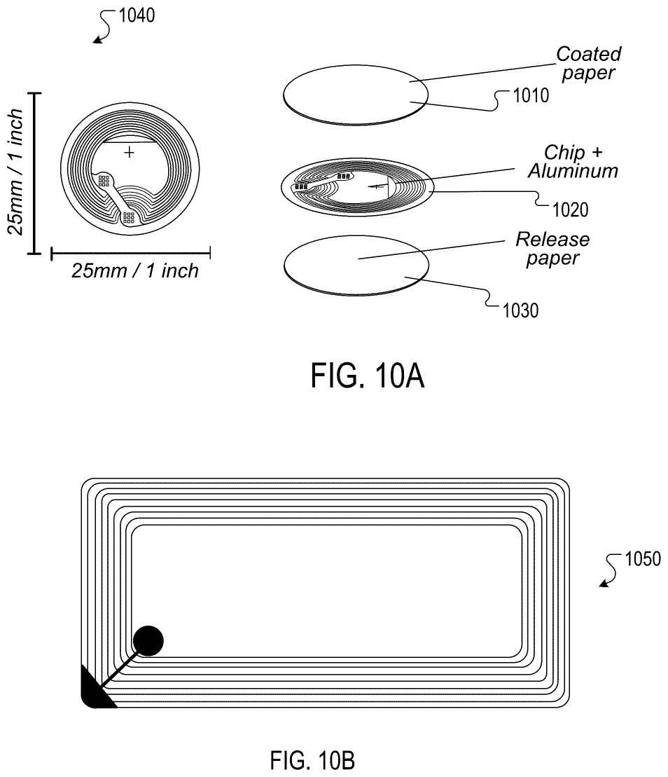

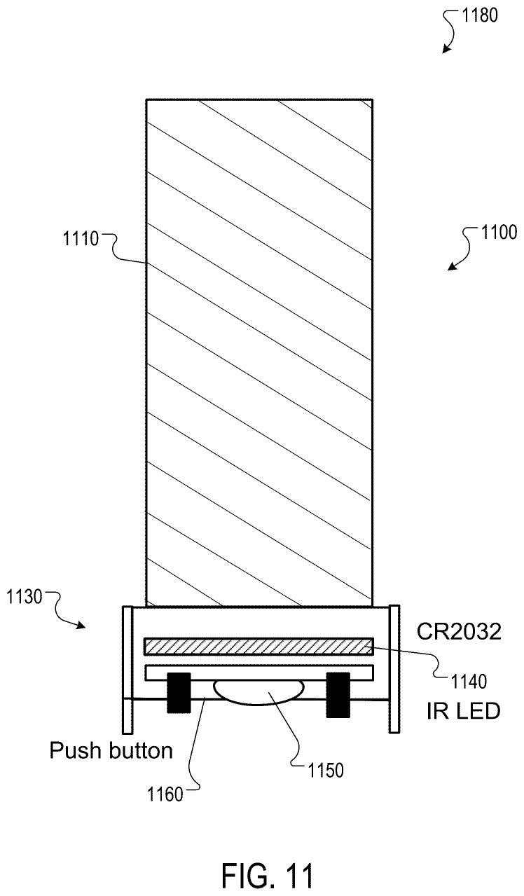

The smart tag 616 can have any appropriate form factor and is configured to be attached to the consumer product 618 in any appropriate manner. In one example, the smart tag 616 is a sticker with an integrated chip that is configured to be attached to the consumer product 618 through an adhesive. In another example, the smart tag 616 is integrated within a packaging of the consumer product 618, e.g., forms a part of the packaging of the consumer product 618. The smart tag 616 is coupled to the consumer product 618 at a location that is proximate to the smart placement mat 614 to facilitate effective reading of the tag 616 by the electronics included in the placement mat 614. For example, the consumer product 618 includes a top portion and a bottom portion opposite the top portion, and the smart tag 616 is coupled to the consumer product 618 at the bottom portion that physically contacts the placement mat 614 when the product 816 is placed on the mat 614. Example placement mat is described in more detail below with reference to FIG. 8, FIG. 9A, and FIG. 9B. Example smart tags are described in more detail below with reference to FIG. 10A, FIG. 10B, FIG. 11A, and FIG. 11B.

The second example architecture of the sensor sub-system 600 obtains measurements that track the consumer product 618 inside the cabinet 610 by emitting radio frequency waves using one or more antennas included in the smart placement mat 614 and reading the smart tag 616 coupled to the consumer product 618. The placement mat 614 reads identification information for the consumer product 618 encoded on the chip included in the smart tag 616. In some cases, the chip is pre-programmed by a merchant of the consumer product 618 to encode data identifying the consumer product 618. The identification data for the consumer product 618 can be any appropriate type of data, e.g., a serial number of the consumer product 618, a bar code, matrix code, or QR code of the consumer product 618, a description of the consumer product 618, or any other appropriate identification data for the consumer product 618. The placement mat 614 is communicatively coupled to the communication module 620, e.g., through a communication network. The placement mat 614 can transmit identification data obtained by reading the smart tag 616 to the communication module 620.

In some cases, if the tag 616 is at a distance away from the mat 614 that is larger than the threshold distance at which the electronics included in the mat 614 can read the tag 616, the mat 614 can transmit a signal to the communication module 620 indicating that the consumer product 618 is removed from the mat 614, e.g., removed from the cabinet 610 for storing the consumer product 618. Similarly, when the consumer product 618 is placed on the mat 614, the mat 614 can read the tag 616 coupled to the consumer product 618 to identify the product 618. In some implementations, the mat 614 can further include one or more sensors configured to detect a movement of the consumer product 618 and, in response, trigger the mat 614 to emit radio frequency waves. The sensor can be, e.g., an accelerometer, a vibration sensor, or any other appropriate sensor configured to detect a movement of the product 618. The one or more sensors can be physically integrated with the mat 614 or communicatively coupled with the mat 614 through a communication network. A remote computing device (e.g., the remote computing device 150 described above with reference to FIG. 1) receives data from the communication module 620 indicating that the product 618 is in proximity to the mat 614, or removed from the mat 614, and/or identification data for the consumer product 618. The remote computing device can process this data to generate insights into consumption or usage of the consumer product 618 by the consumer.

The smart placement mat 614 included in the second example architecture of the sensor sub-system 600 is described in more detail next.

### An Example Placement Mat Included in the Second Architecture of the Sensor Sub-System

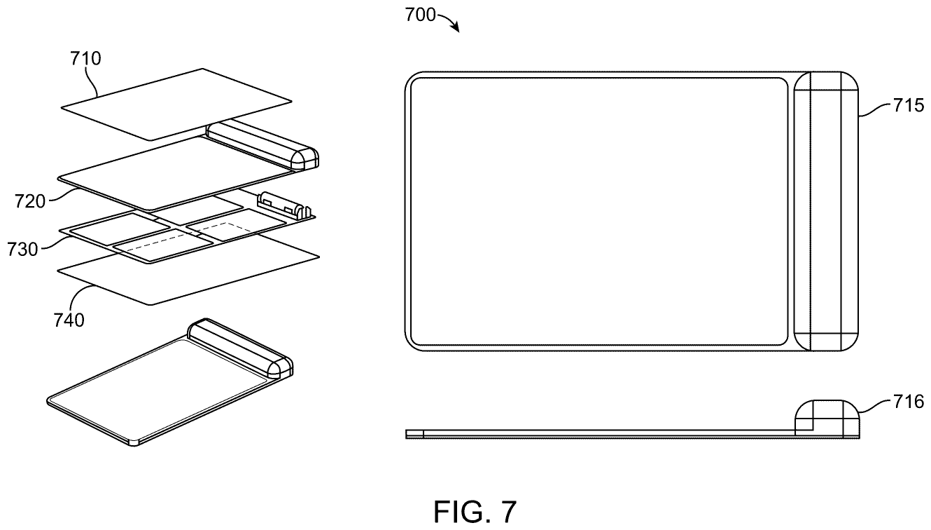

FIG. 7 illustrates an example smart placement mat 700 included in the second example architecture of the sensor sub-system (e.g., the sensor sub-system 600 described above with reference to FIG. 6), which is included in a consumer product tracking system (e.g., the consumer product tracking system 100 in FIG. 1).

As described above, the smart placement mat 700 can include electronics configured to read a smart tag coupled to a consumer product. The electronics included in the mat 700 can be configured according to any appropriate type of RFID technology, e.g., Near Field Communication (NFC), Bluetooth, or any other appropriate type of RFID technology.

Generally, the mat 700 can have any appropriate dimensions and/or form factor suitable for supporting one or more consumer products, e.g., inside a cabinet for storing the one or more consumer product. FIG. 7 illustrates a particular example of a rectangular placement mat 700, where the top view 715 shows that the mat 700 is approximately 292 mm long and 250 mm wide. A side view 715 of the placement mat 700 shows that the mat is approximately 5.4 mm thick at one end and 24 mm thick at the other end. The mat 700 can include multiple layers, e.g., a first 710 (e.g., cover) layer configured to support one or more consumer products, a second layer 720 and a third layer 740 configured to house, or support, the electronics 730 (e.g., one or more radio frequency antennas and any other electronics required for operating and powering the mat 700). The one or more antennas of the mat 700 are described in more detail below with reference to FIG. 8A and FIG. 8B.

In some cases, the mat 700 further includes a battery, or other means, for powering the mat 700, that consume relatively low power. The battery can be primary battery (e.g., designed to be used until exhausted of energy) or rechargeable battery (e.g., can be recharged by virtue of having their chemical reactions reversed by applying electric current to the cell). In some cases, the battery can include one or more of electrochemical cells, such as galvanic cells, electrolytic cells, fuel cells, flow cells, and/or voltaic piles. In some cases, the mat 700 can be powered by electric power extracted (e.g., received) from a power outlet. The mat 700 can additionally include a Wi-Fi module that can be like the Wi-Fi module described above with reference to FIG. 3.

FIG. 8A and FIG. 8B illustrate example electronics included in the placement mat 700 described above with reference to FIG. 7 of the second example architecture of the sensor sub-system (e.g., the sensor sub-system 600 described above with reference to FIG. 6).

FIG. 8A illustrates a single-antenna implementation of the electronics included in the placement mat. This implementation includes a single antenna 810 having any appropriate dimensions, e.g., 77 by 113 mm.

FIG. 8B illustrates a multiple antenna implementation of the electronics included in the placement mat. This implementation includes an array 820 of four antennas 825a, 825b, 825c, 825d. Generally, the electronics can include any appropriate number of antennas arranged in any appropriate manner, e.g., 2 antennas, 3 antennas, 4 antennas, 6 antennas, or any other appropriate number of antennas. Having multiple antennas enables the mat to read multiple smart tags simultaneously, e.g., each tag being coupled to a respective consumer product. The antenna array can have any appropriate dimensions, e.g., 180 mm by 265 mm.

In some cases, the antennas described above with reference to FIG. 8A and FIG. 8B can be disposed on a rigid or flexible printed circuit board (PCB). The flexible PCB can enable the mat to be substantially flexible such that it can be easily disposed in a variety of different locations or types of cabinets for storing the consumer product.

Example smart tags included in the second example architecture of the sensor sub-system are described in more detail next.

### Example Smart Tags Included in the Second Architecture of the Sensor Sub-System

FIG. 9A and FIG. 9B illustrate example smart tags included in the second example architecture of the sensor sub-system (e.g., the sensor sub-system 600 described above with reference to FIG. 6), which is included in a consumer product tracking system (e.g., the consumer product tracking system 100 in FIG. 1).

FIG. 9A illustrates an active tag 915a having an active tag body that includes a top portion 910, a bottom portion 930, a chip 920a, and a battery 940. When compared to a passive tag described in more detail below, the active tag 915a has a longer reading range, more efficient data transmission and capture, and an overall higher performance, than the passive tag. However, the active tag 915a generally has a larger thickness than the passive tag, e.g., approximately 6.5 mm. In some cases, the active tag 915a only draws power from the battery 940 when is it is in an active state. In some cases, the active tag 915a has a 50% duty cycle.

FIG. 9B illustrates a passive tag 915b having a tag body 935 and a chip 920b. The passive tag 915b does not include a battery which can facilitate easy placement on, and integration with, a packaging of the consumer product. The passive tag 915b generally has a smaller thickness than the active tag 915a, e.g., approximately 3.4 mm. The passive tag 915b or the active tag 915b can be chosen according to a particular consumer product on which it is placed, or the location/form factor of the cabinet for storing the consumer product. In some cases, the passive tag 915b is configured to be in an active state (e.g., in a readable state) only when it is in physical contact with the placement mat. In other words, if a consumer product to which the passive tag 915b is attached is removed from the mat, the tag 915b automatically deactivates.

FIG. 10A and FIG. 10B illustrate example attachments of the smart tags (e.g., the active tag 915a and the passive tag 915b described above) included in the second example architecture of the sensor sub-system (e.g., the sensor sub-system 600 described above with reference to FIG. 6).

FIG. 10A illustrates an example smart tag 1040 in the form of a circular sticker. The smart tag 1040 includes a chip 1020 (e.g., an aluminum chip) disposed between a top layer 1010 (e.g., coated paper) and a bottom layer 1030 (e.g., release paper). The smart tag 1040 is substantially flat to facilitate easy attachment to, or integration with, the packaging of the consumer product. In some cases, the circular smart tag 1040 has a diameter of less than 50 mm, less than 40 mm, less than 30 mm, less than 20 mm, or any other appropriate diameter.

FIG. 10B illustrates an example smart tag 1050 similar to the one described above but in the form of a rectangular sticker. The shape of the smart tags can generally be configured according to the type of the consumer product on which it is placed. In some cases, the rectangular smart tag 1050 has any of the following dimensions: 10 by 20 mm, 12 by 18 mm, 15 by 20 mm, 15 by 30 mm, or any other appropriate dimensions.

In some cases, the smart tag 1040, 1050 can include a bar code printed on the tag that is unique to the consumer product for which the tag is intended. In some cases, the smart tag 1040, 1050 is reusable, e.g., can be reprogrammed according to the consumer product for which the tag is intended. The attachment of the smart tag 1040, 1050 can facilitate efficient removal and reattachment of the tag, e.g., on different consumer products.

### A Third Example Architecture of the Sensor Sub-System

FIG. 11 is a block diagram of a third example architecture of the sensor sub-system 1100 (e.g., the sensor sub-system 108 included in the consumer product tracking system 100 in FIG. 1).

As described above with reference to FIG. 1, the sensor sub-system 1100 is configured to obtain measurements that track the consumer product 1110 at one or more locations, e.g., inside a cabinet for storing the consumer product 1110. For example, the sensor sub-system 1100 can detect presence, movement, or absence, of the consumer product 1110 inside the cabinet for storing the consumer product 1110. The consumer product tracking system can process tracking data that includes the measurements obtained by the sensor sub-system 1110 to generate insights into consumption or usage of the product 1110 by the consumer.

The third example architecture of the sensor sub-system 1100 includes a tracker device 1130 having a switch 1150, transmitter 1160, and a battery 1140. The tracker device 1130 can be coupled, e.g., physically coupled, to the consumer product 1110. In some cases, the consumer product 1110 includes a top portion and a bottom portion, where the bottom portion is opposite the top portion. The tracker device 1130 can physically contact the consumer product 1110 at the bottom portion of the consumer product 1110. The switch 1150 can be any appropriate type of switch, e.g., a mechanical switch such as a push button, and the switch 1150 can be configured to trigger the transmitter 1160 to transmit an identification signal in response to the actuation of the switch 1150 due to the consumer product 1110 being lifted, put down, or otherwise moved relative to the switch 1150.

The battery 1140 can be configured to power the transmitter 1160. Some examples of transmitters 1160 include a light transmitter, e.g., an infrared light transmitter, or a radio wave transmitter. In response to actuation by the switch 1150, the transmitter 1160 can transmit, e.g., a light or radio wave signal that can be specific to the consumer product 1110, e.g., can identify the consumer product 1110. In some cases, the light signal emitted by the transmitter 1160 is a structured light signal, e.g., a projection of a light pattern. As a particular example, the transmitter 1160 operates at approximately 37 kHz and has a duty cycle of 50%.

The light/radio wave signal can reflect from the cabinet for storing the consumer product 1110 where the consumer product 1110 is disposed. A receiver 1180 disposed at a location remote from the tracker device 1130 (e.g., at a different location inside the cabinet for storing the consumer product 1110) can receive the signal. The receiver is communicatively coupled to the communication module through a communication network. The communication module receives the signal and transmits tracking data that includes the signal to the remote computing device. The remote computing device can process the tracking data and generate insights into consumption or usage of the consumer product 1110 by the consumer.

### Generation of Insights Based on Tracking Data

As described above with reference to FIG. 1, the consumer product tracking system uses the sensor sub-system to obtain measurements tracking the consumer product and generates tracking data that includes the measurements tracking the consumer product. Generally, in addition to the measurements obtained by the sensor sub-system, the tracking data can include, e.g., timestamped data indicating a time when the measurements were obtained, identification data for the consumer product, images of the consumer product and/or the cabinet obtained by the camera module, motion data characterizing a motion pattern of the consumer product (e.g., if the sensor sub-system includes an accelerometer), a location of the consumer product, and/or any other appropriate type of data.

The consumer product tracking system transmits tracking data to a remote computing device that processes the tracking data using a machine learning algorithm, or in any other appropriate manner, to generate insights into consumption or usage of the consumer product by the consumer. The machine learning model may have been trained on historical tracking data for the consumer product, and/or other similar data, all of which can be of the consumer or user and/or other consumer or users of same or similar products. The machine learning model may have been trained previously by and/or on the remote computing device and/or any other one or more devices.

The machine learning model can be configured to analyze the images captured by the camera module, e.g., perform image recognition. The machine learning model that is trained and deployed to perform machine learning can be a supervised model (e.g., a model that involves learning a function that maps an input to an output based on example input-output pairs) or an unsupervised model (e.g., a model used to draw inferences and find patterns from input data without references to labeled outcomes). The supervised model can be a regression model (e.g., model where output is continuous) or a classification model (e.g., model where the output is discrete).

The regression model can be one or more of: (a) a linear regression model (e.g. a model that finds a line or curve that best fits the data), (b) a decision tree model (e.g. a model that has nodes, where the last nodes of the tree that are also referred to as leaves of the tree make decisions, where the number of nodes can be increased to enhance accuracy of the decision making and number of nodes can be decreased to enhance speed to reduce latency), (c) random forest model (e.g. model that involves creating multiple decision trees using bootstrapped datasets of the original data and randomly selecting a subset of variables at each step of the decision tree, where this model advantageously reduces the risk of error from an individual tree), (d) a neural network (e.g. a model that receives a vector of inputs, performs equations at various stages, and generates a vector of outputs), and/or the like.

The classification model can be one or more of: (a) a logistic regression model (e.g. a model that is similar to linear regression but is used to model the probability of a finite number of—e.g. two—outcomes; for instance, a logistic curve or equation may be created in such a way that the output values can only be between 0 and 1), (b) a support vector machine (e.g. a model that finds a hyperplane or a boundary between two classes of data that maximizes the margin or distance between the two classes), (c) naïve bayes model (e.g. a model that determines a class by implementing the bayes theorem).

The unsupervised learning models can be one or more of: (a) clustering models (e.g. a model that involves the grouping, or clustering, of data points, wherein such models can involve various clustering techniques such as k-means clustering, hierarchical clustering, mean shift clustering, and density-based clustering), and (b) dimensionality reduction models (e.g. a model that eliminates or extracts features to reduce the number of random variables under consideration by obtaining a set of principal variables), and/or the like.

The remote computing device can implement any of these machine learning models to generates insights based on the tracking data. Some insights are specific to and beneficial for the consumer or user, and certain insights are specific to and beneficial for a merchant (e.g., manufacturers, distributors, retailers, and/or the like) of the product. The insights can include qualitative insights and quantitative insights.

The remote computing device can (a) implement a rewards system to reward the consumer or user for tracking the consumption or usage of the product, (b) generate a report that will be helpful for an entity (e.g. merchant—such as manufacturers, distributors, retailers, and/or the like—of the product, and (c) generate a report that will be helpful for the consumer or user. The reports can include respective insights, which can be qualitative and/or quantitative in various implementations.

The rewards system can be a points-based system to determine reward points to the consumer or user for tracking his or her consumption or usage of the product. In various implementations, the remote computing device can allocate reward points to the consumer or user based on (a) tracking consumption or usage of one or more products, (b) using the communication device for performing various activities (e.g., responding to various prompts in the form of questions or requests for performance of tasks), and/or the like. The remote computing device can also map the rewards points to one or more payment means such as cash, gift cards, cryptocurrency, or the like.

The remote computing device can generate one or more reports including the qualitative insights and the quantitative insights. For example, the remote computing device can generate a report for the consumer or user that includes the insights specific to the consumer or user, and another report for the entity (e.g., merchant—such as manufacturers, distributors, retailers, and/or the like—of the product) that includes the insights specific to the entity.

The qualitative and quantitative insights may include the usage of the product at various time periods. The report may include any of: a graphical representation of the usage of the product over a period of time, and/or a tabular column elaborating the usage of the product over the period of time. In some implementations, the period of time can vary from a first time (e.g., week 1) to a subsequent or last time (e.g., week 52). In a few implementations, the report includes the graphical representation of the consumption or usage of one or more products used by the consumer or user. In certain implementations, the report includes the graphical representation of the usage of one specific product. The remote computing device generates report with qualitative and quantitative insights that reflect accurate usage and/or consumption of the product with less or no human intervention or error. In some implementations, the remote computing device generates report that includes the qualitative and quantitative insights comprising the usage of one or more products by one or more consumers or users and the timestamps to determine the usage behavior of the one or more products by the one or more consumers or users.

### Example Computer System

FIG. 12 is a block diagram of an example computer system 1200 (which, in some examples, can be one or more computing components within the system 100) that can be used to perform operations described above, according to some implementations described herein. The system 1200 includes a processor 1210, a memory 1220, a storage device 1230, and an input/output device 1240. Each of the components 1210, 1220, 1230, and 1240 can be interconnected, for example, using a system bus 1250. The processor 1210 is capable of processing instructions for execution within the system 1200. In some implementations, the processor 1210 is a single-threaded processor. In another implementation, the processor 1210 is a multi-threaded processor. The processor 1210 is capable of processing instructions stored in the memory 1220 or on the storage device 1230.

The memory 1220 stores information within the system 1200. In one implementation, the memory 1220 is a computer-readable medium. In some implementations, the memory 1220 is a volatile memory unit. In another implementation, the memory 1220 is a non-volatile memory unit.

The storage device 1230 can provide mass storage for the system 1200. In some implementations, the storage device 1230 is a computer-readable medium. In various implementations, the storage device 1230 can include, for example, a hard disk device, an optical disk device, a storage device that is shared over a network by multiple computing devices (e.g., a cloud storage device), or some other large capacity storage device.

The input/output device 1240 provides input/output operations for the system 1200. In some implementations, the input/output device 1240 can include one or more of a network interface device, e.g., an Ethernet card, a serial communication device, e.g., and RS-232 port, and/or a wireless interface device, e.g., and 802.11 card. In another implementation, the input/output device can include driver devices configured to receive input data and send output data to external devices 1260, e.g., keyboard, printer and display devices. Other implementations, however, can also be used, such as mobile computing devices, mobile communication devices, set-top box television client devices, etc.

Although an example processing system has been described in FIG. 12, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, e.g., one or more modules of computer program instructions, encoded on computer storage media (or medium) for execution by, or to control the operation of, data processing apparatus. Alternatively, or in addition, the program instructions can be encoded on an artificially-generated propagated signal—e.g., a machine-generated electrical, optical, or electromagnetic signal—that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The term module, as noted herein, can include software instructions and codes to perform a designated task or a function. A module as used herein can be a software module or a hardware module. A software module can be a part of a computer program, which can include multiple independently developed modules that can be combined or linked via a linking module. A software module can include one or more software routines. A software routine is computer readable code that performs a corresponding procedure or function. A hardware module can be a self-contained component with an independent circuitry that can perform various operations described herein.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In addition to the embodiments of the attached claims and the embodiments described above, the following numbered embodiments are also innovative.

Embodiment 1 is a system for tracking use of a consumer product stored in a cabinet, the system comprising: a sensor configured to sense a change in a state of a door of the cabinet; a camera module comprising a camera, the camera module being communicatively coupled to the sensor, the camera module being configured to acquire images of an interior of the cabinet in response to a change in the state of the cabinet door sensed by the sensor; a communication module communicatively coupled to the camera, the communication module being configured to wirelessly transmit image data comprising the images of the interior of the cabinet; and a computing device remote from the cabinet and communicatively coupled to the communication module, the computing device being configured to receive the image data and analyze the image data to generate tracking data related to use of the consumer product based on the analysis of the image data.

Embodiment 2 is the system of embodiment 1, wherein the sensor comprises one or more of: a motion sensor, a proximity sensor, a location sensor, a light sensor, and a touch sensor.

Embodiment 3 is the system of any of embodiments 1-2, wherein the camera module comprises a housing having a front side and a back side, the camera comprising a camera lens arranged to image a field on the front side of the camera module, and an attachment means configured to attach the back side to a surface of the interior of the cabinet.

Embodiment 4 is the system of embodiment 3, wherein the attachment means comprises an adhesive tape or one or more suction cups.

Embodiment 5 is the system of any of embodiments 3-4, wherein the camera module further comprises a light source configured to illuminate an interior of the cabinet during the acquisition of the images.

Embodiment 6 is the system of embodiment 5, wherein the camera is configured to capture the images of the interior portion of the cabinet at regular time intervals.

Embodiment 7 is the system of any of embodiments 3-6, wherein the camera module further comprises an ambient light sensor, and wherein the ambient light sensor is configured to sense the change in the state of the cabinet for storing the consumer product.

Embodiment 8 is the system of any of embodiments 3-7, wherein the camera lens is a wide-angle lens or a fisheye lens.

Embodiment 9 is the system of any of embodiments 1-8, wherein the camera comprises a field of view in at least once direction of 80 degrees or more.

Embodiment 10 is the system of any of embodiments 1-9, wherein the remote computing device is configured to analyze the image data of the cabinet using a machine learning model.

Embodiment 11 is the system of embodiment 10, wherein the machine learning model is an image recognition machine learning model.

Embodiment 12 is the system of any of embodiments 1-11, wherein the consumer product is selected from the group consisting of a consumer packaged good (CPG), a medication, a fast moving consumer good (FMCG), and a food & beverage (F&B).

Embodiment 13 is the system of any of embodiments 1-12, wherein the communication module comprises a module selected from the group consisting of a Wi-Fi module, a Bluetooth module, a Bluetooth Low Energy module, and a SIM module.

Embodiment 14 is the system of any of embodiments 1-13, wherein the tracking data comprises information identifying a type of the consumer product.

Embodiment 15 is the system of any of embodiments 1-14, wherein the tracking data comprises one or more of information that the consumer product has been removed from the cabinet or information that the consumer product has been placed in the cabinet.

Embodiment 16 is the system of any of embodiments 1-15, wherein the camera is configured to periodically acquire the images.

Embodiment 17 is the system of any of embodiments 1-16, wherein the cabinet is a refrigerator, a freezer, or a cupboard.

Embodiment 18 is a method comprising: sensing, by a sensor coupled to a cabinet, a change in a state of a cabinet door of the cabinet; in response to the sensed change in the state of the cabinet door, capturing, by a camera, images of an interior portion of the cabinet; wirelessly transmitting, by a communication module communicatively coupled to the camera, image data comprising the images of the interior of the cabinet; and analyzing, by a remote computing device communicatively coupled to the communication module, the image data to generate tracking data related to use of the consumer product based on the analysis of the image data.

Embodiment 19 is the method of embodiment 18, wherein analyzing, by the remote computing device communicatively coupled to the communication module, the image data to generate tracking data for the consumer product comprises: processing, by the remote computing device, the image data to determine an activity performed by a consumer associated with the consumer product.

Embodiment 20 is the method of any of embodiments 18-19, further comprising: generating, by the remote computing device, a report on consumption or use of the consumer product by the consumer based on the tracking data for the consumer product; and transmitting, from the remote computing device, the report to a merchant device of the merchant of the consumer product.

Embodiment 21 is a system comprising: a smart tag configured to be attached to a consumer product; a placement mat comprising a surface configured to support the consumer product, the placement mat comprising electronics configured to: read the smart tag in response to a sensed change in a state of the consumer product, wherein the sensed change in the state of the consumer product comprises moving of the consumer product relative to the placement mat; and based on reading the smart tag, generate identification data for the consumer product; a communication module communicatively coupled to the placement mat, the communication module configured to wirelessly transmit the identification data; and a remote computing device communicatively coupled to the communication module, the remote computing device configured to receive the identification data and generate tracking data for the consumer product based on the identification data.

Embodiment 22 is the system of embodiment 21, wherein the smart tag is a Near Field Communication (NFC) tag, a Radio Frequency Identification (RFID) tag, or a Bluetooth tag.

Embodiment 23 is the system of any of embodiments 21-22, wherein the electronics are configured to read a plurality of smart tags simultaneously.

Embodiment 24 is the system of any of embodiments 21-23, wherein the smart tag comprises an adhesive for attaching the smart tag to the consumer product.

Embodiment 25 is the system of any of embodiments 21-24, wherein the communication module comprises one or more antennae.

Embodiment 26 is the system of any of embodiments 21-25, wherein the smart tag is a reusable smart tag configured to be attached to a second different consumer product after detachment from the consumer product.

Embodiment 27 is the system of any of embodiments 21-26, wherein the movement of the consumer product relative to the placement mat comprises removing the consumer product from the placement mat or placing the consumer product on the placement mat.

Embodiment 28 is the system of any of embodiments 21-27, wherein the communication module is integrated with the placement mat and the communication module comprises a Wi-Fi module.

Embodiment 29 is the system of any of embodiments 21-28, wherein the placement mat further comprises a power source configured to supply power to the placement mat.

Embodiment 30 is the system of any of embodiments 21-29, wherein the smart tag attached to the consumer product on a surface of the consumer product that is in direct contact with the surface of the placement mat.

Embodiment 31 is the system of any of embodiments 21-29, wherein the placement mat comprises a sensor configured to: sense the change in the state of the consumer product; and in response to the sensed change in the state of the consumer product, trigger the placement mat to read the smart tag attached to the consumer product.

Embodiment 32 is the system of embodiment 31, wherein the sensor is an accelerometer or a vibration sensor.

Embodiment 33 is the system of any of embodiments 21-32, wherein the smart tag is an active tag or a passive tag.

Embodiment 34 is the system of any of embodiments 21-33, wherein the computing device is configured to program the smart tag with information regarding the consumer product.

Embodiment 35 is the system of any of embodiments 21-34, wherein the placement mat is configured to read the smart tag of each of a plurality of consumer products that are stacked on the surface of the placement mat.

Embodiment 36 is a method, comprising: providing a smart tag for attachment to a consumer product; providing a placement mat for supporting the consumer product; sensing, using the placement mat, a change in a state of the consumer product, the sensed change in the state of the consumer product comprising movement of the consumer product relative to the placement mat; in response to the sensed change, reading, using the placement mat, the smart tag attached to the consumer product to generate identification data for the consumer product; wirelessly transmitting, by a communication module communicatively coupled to the placement mat, the identification data for the consumer product; and analyzing, by a remote computing device communicatively coupled to the communication module, the identification data for the consumer product to generate tracking data for the consumer product.

Embodiment 37 is a system comprising: a tracker device configured to be coupled to a consumer product, the tracker device comprising a switch and a transmitter, the switch being configured to trigger the transmitter to transmit an identification signal in response to a sensed change in a state of the consumer product, wherein the sensed change in the state of the consumer product comprises moving the consumer product relative to a cabinet in which the consumer product is placed; a receiver disposed at an interior portion of the cabinet, the receiver configured to receive the identification signal from the transmitter; and a remote computing device communicatively coupled to the receiver, the remote computing device configured to receive the identification signal from the receiver and generate tracking data for the consumer product based on the identification signal.

Embodiment 38 is the system of embodiment 37, wherein the transmitter is configured to transmit an optical signal or a radio wave signal.

Embodiment 39 is the system of embodiment 38, wherein the optical signal comprises an infrared (IR) light sequence.

Embodiment 40 is the system of any of embodiments 37-39, wherein the switch is a mechanical switch.

Embodiment 41 is the system of any of embodiments 37-40, wherein the tracker device further comprises a power source configured to supply a power to the tracker device.

Embodiment 42 is the system of any of embodiments 37-41, wherein the identification signal is a pre-programmed code associated with the tracker device.

Embodiment 43 is the system of any of embodiments 37-42, wherein the consumer product comprises a container having top surface and a bottom surface opposite the top surface, and wherein the tracker device is coupled to the container proximate to the bottom surface.

Embodiment 44 is the system of any of embodiments 37-43, wherein the receiver is disposed proximate to the top surface.

Embodiment 45 is the system of any of embodiments 37-44, wherein the switch is a push button.

Embodiment 46 is the system of any of embodiments 37-45, wherein the transmitter has a duty cycle in a range from 40% and 60%.

Embodiment 47 is a method comprising: providing a tracker device coupled to a consumer product disposed in a cabinet, the tracker device comprising a switch and a transmitter; triggering, by the switch, the transmitter to transmit an identification signal in response to a sensed change in a state of the consumer product, wherein the sensed change in the state of the consumer product comprises movement of the consumer product relative to the cabinet; receiving, by a receiver disposed at an interior portion of the cabinet, the identification signal from the transmitter; and analyzing, by a remote computing device communicatively coupled to the receiver, the identification signal to generate tracking data for the consumer product.

Embodiment 48 is a computer-implemented method that comprises the operations of any of embodiments 1-17, 21-35, and 37-46.

Embodiment 49 is a computer program carrier encoded with a computer program, the program comprising instructions that are operable, when executed by one or more computers, to cause the one or more computers to perform the method of any one of embodiments 18-20, 36, and 47-48.

While this specification contains many specific implementation details, these should not be construed as limitations on the scope of any innovations or of what may be claimed, but rather as descriptions of features specific to particular implementations of specific innovations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, specific implementations of the subject matter have been described. Other implementations are within the scope of the claims. In some cases, the actions recited in the claims can be performed in a different order and still achieve desirable results. In addition, the processes depicted in the accompanying figures do not necessarily require the order shown, or sequential order, to achieve desirable results. In certain implementations, multitasking and parallel processing may be advantageous.

What is claimed is:

1. A system for tracking use of a consumer product stored in a cabinet, the system comprising:
a sensor configured to sense a change in a state of a door of the cabinet;
a camera module comprising a camera, the camera module being communicatively coupled to the sensor, the camera module being configured to acquire images of an interior of the cabinet in response to a change in the state of the cabinet door sensed by the sensor;
a communication module communicatively coupled to the camera, the communication module being configured to wirelessly transmit image data comprising the images of the interior of the cabinet; and
a computing device remote from the cabinet and communicatively coupled to the communication module, the computing device being configured to receive the image data and analyze the image data to generate tracking data related to use of the consumer product based on the analysis of the image data.

2. The system of claim 1, wherein the sensor comprises one or more of: a motion sensor, a proximity sensor, a location sensor, a light sensor, and a touch sensor.

3. The system of claim 1, wherein the camera module comprises a housing having a front side and a back side, the camera comprising a camera lens arranged to image a field on the front side of the camera module, and an attachment means configured to attach the back side to a surface of the interior of the cabinet.

4. The system of claim 3, wherein the attachment means comprises an adhesive tape or one or more suction cups.

5. The system of claim 3, wherein the camera module further comprises a light source configured to illuminate an interior of the cabinet during the acquisition of the images.

6. The system of claim 5, wherein the camera is configured to capture the images of the interior portion of the cabinet at regular time intervals.

7. The system of claim 3, wherein the camera module further comprises an ambient light sensor, and wherein the ambient light sensor is configured to sense the change in the state of the cabinet for storing the consumer product.

8. The system of claim 3, wherein the camera lens is a wide-angle lens or a fisheye lens.

9. The system of claim 1, wherein the camera comprises a field of view in at least once direction of 80 degrees or more.

10. The system of claim 1, wherein the remote computing device is configured to analyze the image data of the cabinet using a machine learning model.

11. The system of claim 10, wherein the machine learning model is an image recognition machine learning model.

12. The system of claim 1, wherein the consumer product is selected from the group consisting of a consumer packaged good (CPG), a medication, a fast moving consumer good (FMCG), and a food & beverage (F&B).

13. The system of claim 1, wherein the communication module comprises a module selected from the group consisting of a Wi-Fi module, a Bluetooth module, a Bluetooth Low Energy module, and a SIM module.

14. The system of claim 1, wherein the tracking data comprises information identifying a type of the consumer product.

15. The system of claim 1, wherein the tracking data comprises one or more of information that the consumer product has been removed from the cabinet or information that the consumer product has been placed in the cabinet.

16. The system of claim 1, wherein the camera is configured to periodically acquire the images.

17. The system of claim 1, wherein the cabinet is a refrigerator, a freezer, or a cupboard.

18. A system, comprising:
a smart tag configured to be attached to a consumer product;
a placement mat comprising a surface configured to support the consumer product, the placement mat comprising electronics configured to:
read the smart tag in response to a sensed change in a state of the consumer product, wherein the sensed change in the state of the consumer product comprises moving of the consumer product relative to the placement mat; and
based on reading the smart tag, generate identification data for the consumer product;
a communication module communicatively coupled to the placement mat, the communication module configured to wirelessly transmit the identification data; and
a remote computing device communicatively coupled to the communication module, the remote computing device configured to receive the identification data and generate tracking data for the consumer product based on the identification data.

19. The system of claim18, wherein the smart tag is a Near Field Communication (NFC) tag, a Radio Frequency Identification (RFID) tag, or a Bluetooth tag.

20. A system, comprising:
a tracker device configured to be coupled to a consumer product, the tracker device comprising a switch and a transmitter, the switch being configured to trigger the transmitter to transmit an identification signal in response to a sensed change in a state of the consumer product, wherein the sensed change in the state of the consumer product comprises moving the consumer product relative to a cabinet in which the consumer product is placed;
a receiver disposed at an interior portion of the cabinet, the receiver configured to receive the identification signal from the transmitter; and
a remote computing device communicatively coupled to the receiver, the remote computing device configured to receive the identification signal from the receiver and generate tracking data for the consumer product based on the identification signal.
